(19) United States
(12) Patent Application Publication
(10) Pub. No.: US 2016/0092900 A1
(43) Pub. Date: Mar. 31, 2016

(54) SYSTEM FOR ARRANGING PRODUCT TRIAL PRESENTATION WITH RETAILER FOR SUBSEQUENT ONLINE PURCHASE

(71) Applicant: BINDU RAMA RAO, LAGUNA NIGUEL, CA (US)

(72) Inventor: BINDU RAMA RAO, LAGUNA NIGUEL, CA (US)

(21) Appl. No.: 14/501,032

(22) Filed: Sep. 30, 2014

(51) Int. Cl. G06Q 30/02; G06Q 20/14

(52) U.S. Cl. CPC G06Q 30/0213; G06Q 20/145

(57) ABSTRACT

A sales promotion system supporting a plurality of buyer and a plurality of sellers, wherein the sellers are online sellers or brick and mortar sellers, and some sellers can charge a fee for letting a potential buyer try a product before purchasing it online at a different seller. The sales promotion system makes an arrangement for a trial by potential buyers at some seller's premises, and subsequently helps the seller charge a fee for the trial, while the actual purchase is conducted with a different online seller.

### BACKGROUND

1. Technical Field

The present invention relates generally to online sales, and more particularly to a sales promotion system where a user is presented a trail offer at a brick and mortar store prior to completing an online sale, for a small fee.

2. Related Art

Mobile devices are becoming ubiquitous. Children carry them and so do adults. Most people conduct online purchases of products, often without getting a chance to look and feel the product, and they eventually regret having brought the product without being able to see it before a purchase.

Users often purchase expensive products online from Amazon or other online sales stores. But end up having a product that they do not like, that does not fit them, or one that was not exactly what they expected it to be. Such an experience is likely to cost them time and money and cause dissatisfaction with the online sales companies.

Some people visit brick and mortar stores just to look at products, not to buy them. Subsequently they buy the same products online at a reduced price. The brick and mortar stores thus lose money, although it has people walking in and out to look at products.

Some people purchase clothes and shoes online only to later realize after delivery that they do not fit them properly. This is one of the most common problems with purchasing products online, and often results in monetary loss to the buyer as the buyer has to pay extra to ship the products back to the online store, or lose all the money.

In view of the foregoing considerations, it is clear that there is a need for an improved system and method for creating and sharing property evaluation information that can be used by real-estate agents in assisting their customer needs.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a perspective block diagram of a sales infrastructure supporting a plurality of buyer and a plurality of sellers, wherein the sellers are online sellers or brick and mortar sellers, and some sellers can charge a fee for letting a potential buyer try a product before purchasing it online at a different seller.

FIG. 2 is perspective block diagram of a sales infrastructure with a promotion system that makes it possible for a user to select a product online for purchase at a first online seller, try that same or similar product out at a retail brick and mortar store for a trail fee, and subsequently purchase it at the online seller.

FIG. 3 is an exemplary method of operation of a promotion system that arranges product trials for an online buyer at a retail store for a trail fee, and also supports subsequent purchase at an online sales server.

FIG. 4 is an exemplary method of operation 401 of a promotion system 207 that arranges product trials for an online buyer at a retail store for a trail fee, and also supports subsequent purchase at an online sales server.

FIG. 5 is a perspective block diagram of an exemplary sales infrastructure with a promotion system that brings together an online seller's system and a brick and mortar seller's system and arranges a fee paid trail of a product at the brick and mortar seller's store for eventual online purchase of a product by the buyer at the online server's website.

### DETAILED DESCRIPTION OF THE DRAWINGS

The present invention provides a sales promotion system that makes it possible for an online buyer to try a product at a retail store for a small fee before completing the purchase online with an online seller.

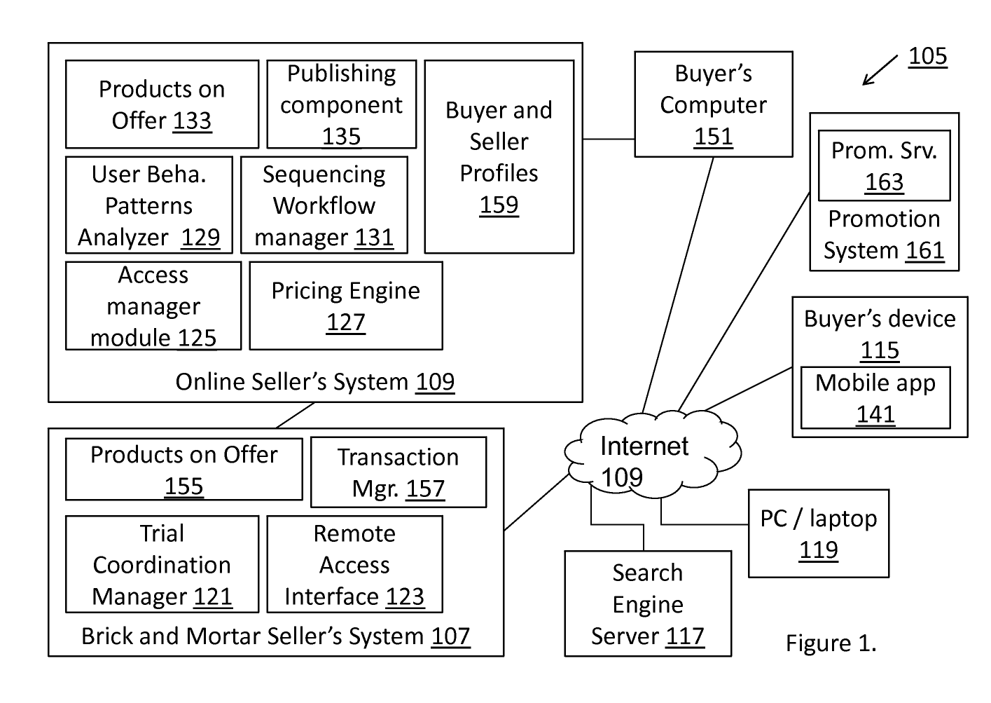

FIG. 1 is a perspective block diagram of a sales infrastructure 105 supporting a plurality of buyer and a plurality of sellers, wherein the sellers are online sellers or brick and mortar sellers, and some sellers can charge a fee for letting a potential buyer try a product before purchasing it online at a different seller. The buyers each employ a plurality of buyer devices 115, 151 such as mobile phones 115, tablets, notebook computers 151, laptops, etc. The sellers employ a corresponding plurality of seller devices 109 such as computers, laptops 119, servers, mobile phones etc. The sales promotion system 161 in the sales infrastructure 105 makes an arrangement for a trial by potential buyers at some seller premises, and subsequently helps the seller charge a fee for the trial, while the actual purchase is conducted with a different online seller. The sales infrastructure 105 employs a sales promotion system 161 for arranging product trial presentation with one of a plurality of retailers for subsequent online purchase, such as at a different online sales system that is not affiliated with the retailer.

The sales infrastructure 105 comprises the promotion system 161 which inturn comprises a promotion server 163 that supports promotion of sales of a plurality of products from a plurality of sellers 107, 109, including a first product from a first seller. The promotion server 163 of the promotion system 161 is responsive to a selection of the first product received from one of the plurality of buyer devices. It delivers to the one of the plurality of buyer devices 115 a first trial presentation offer at a second seller premises at a first trail fee.

The promotion server 163 is also responsive to a trail offer acceptance received related to the first trial presentation offer, and it makes an appointment for a visit to the second seller premises by a user associated with the one of the plurality of buyer devices 115 to conduct a trail. The second seller employs an associated brick and mortar seller system 107 for online sales and offline instore sales, etc.

The promotion server 163 is also responsive to a receipt of a successful trail indication from the one of the plurality of buyer devices 115, and in response it conducts a first sales transaction with the first seller for the first product, and in addition, conducts a fee payment transaction for the first trial presentation with the second seller. The first seller employs an online seller's system 109 for sales promotion, online sales transaction execution, etc.

The sales infrastructure 105 supports the first seller who is an online only seller (employing online seller's system 109) with online presence on the Internet. It also supports the second seller that is a brick and mortar seller (employing brick and mortar seller's system 107) with one or more physical sales premises. A buyer can review products at an online store (such as Amazon, ebay, etc.) and automatically (or based on user request alternately) receive from the promotion system 161 an option to try the product(s) at a local retail store, department store, etc. If user approves of a suggested local store, the promotion system 161 makes an appointment with the local store, and sends a confirmation to the buyer onto his buyer's device 115, 151. The local store, in one embodiment, is determined by the promotion system 161 based on at least one of the buyer's GPS location (based on mobile device 115, for example), current location, default location, known address, etc. The buyer shows up for a trial of the product(s) at the local store, where he can touch it, feel it, try it, experience using it, etc. Then the local store sends a confirmation message to the promotion system 161 indicating successful completion of trial. In one embodiment, the user sends a confirmation of the end of trial. The local store then gets a trial fee from the promotion system 161 at purchase of product by the buyer, for example. The buyer completes purchase online using buyer's computer 151 or buyer's device 115, and a portion of his payment pays for the trial fee for the local store, in one embodiment. In another embodiment, the online sales server (such as Amazon, ebay, etc.—which do not provide any such services or features currently) reimburses a portion of their profits to the local store for the services rendered towards the product trial by the buyer. In another embodiment, the product manufacturer pays the trial fee that is paid to the local store.

The present invention turns local stores, department stores etc., where a buyer can try a product before buying them online, into a showroom of sorts, into a trial location where the retailer gets paid for trail services rendered. Thus, local retail stores can earn some extra revenues by letting online buyers try the products they are interested in, before they complete their purchase online. The trial fee charged to the buyer, the online store or the product manufacturer compensates them for the cost of rendering their trial services at their premises. In addition, a buyer who shows up for a trial may be tempted to buy other products at the store, or buy the same product after the trial. There will be opportunities to upsell too, and make the buyer buy a better product at the local store.

In one embodiment, using the sales promotion system 161, the first seller pays the fees associated with fee payment transaction for the first trial presentation with the second seller. In a related embodiment, the user of the one of the plurality of buyer devices 115 pays the fees associated with fee payment transaction for the first trial presentation with the second seller. In another related embodiment, a product manufacturer associated with the first product pays the fees associated with fee payment transaction for the first trial presentation with the second seller.

In general, an arranged product trial comprises the ability of the buyer to take a look of the product(s), feel the texture, touch the surfaces, the insides, etc. It also makes it possible for the buyer to try the product, and experience how it feels.

The products that the online seller's system 109 supports for online sales includes shoes, clothes, suits, jewelry, electronic items, kitchen appliances, books, watches, expensive jewelry, etc.

The sales promotion system 161 employs a method of operation that supports a plurality of buyer devices used by a corresponding plurality of buyers. It promotes sales of a plurality of products from a plurality of sellers, including a first product from a first seller, by a promotion server in the sales promotion system. If a potential buyer selects the first product for purchase, it responds to a selection of the first product received from one of the plurality of buyer devices 115, 151 by delivering to the one of the plurality of buyer devices 115 a first trial presentation offer at a second seller premises at a first trail fee. The sales infrastructure 105 responds to a trail offer acceptance received related to the first trial presentation offer by making an appointment for a visit to the second seller premises by a user associated with the one of the plurality of buyer devices 115 to conduct a trail. For example, an arrangement of the trial requires sending buyer information, first product information, to the seller system, such as the brick and mortar seller system 107, to make an appointment for the trial. The sales infrastructure 105 responds to a receipt of a successful trail indication from the one of the plurality of buyer devices 115 by conducting a first sales transaction with the first seller for the first product, (via the online seller's system 109 for example) and in addition, conducting a fee payment transaction for the first trial presentation with the second seller (via the brick and mortar seller system 107 for example). The trial conducted by the buyer involves being able to look at, feel, touch and try the product for experience, etc.

The sales promotion system 161 employs a method of operation wherein the first seller is an online only seller with online presence on the Internet while the second seller is a brick and mortar seller with one or more physical sales premises, in one embodiment. In a related embodiment, the first seller (using online seller's system 109 for example) pays the fees associated with fee payment transaction for the first trial presentation with the second seller (using the brick and mortar seller system 107 for example). In yet another embodiment, the user of the one of the plurality of buyer devices (the potential buyer) pays the fees associated with fee payment transaction for the first trial presentation with the second seller. In a different embodiment, a product manufacturer associated with the first product pays the fees associated with fee payment transaction for the first trial presentation with the second seller. Thus, in several embodiments, the buyer does not have to pay the trial fee, the online seller pays it (or part of it) or the manufacturer of the first product pays all or part of the trial fee.

Product evaluations can also be sent by the online seller's system 109 to a social group visited by the buyer and every member of that social group receives the product evaluations posted for review, by other buyers. The recipients of the product evaluations can be managed by the online seller's system 109. The products can then be selected for purchase by a buyer using the buyer's device 115, or more specifically, using the mobile app 141 in the buyer's device 115. In one related embodiment, only specific members of a social group, who may be colleagues working together, or members of a buyer's club, can be assigned rights to review the product evaluations and subsequently make appointments to try the products at local retail stores, etc. In another related embodiment, only members of a friends list created by a one of the buyers for sharing product information and evaluations are provided rights to review conduct product trials, such as at a local retail store. In general, when social groups are used to share product lists and product evaluation, some subset of a social group can be provided rights to buy in bulk, try products before purchase, get discounts, etc.

In one embodiment, the promotion system 161 offers and manages communication between a buyer and a plurality of local brick and mortar stores that offer products for sale and for trial (for a fee, that may be charged to an online store where the user completes a sale, for example). The promotion system 161 interacts with the buyer's computer 151 or buyer's device in arranging product trial appointments, in receiving confirmation that the trial was successfully completed, in getting approval from user to complete a purchase of the product(s) with an online seller system 129, etc.

The promotion system 161 comprises a promotion service employing the promotion server 163 that enable presentation of the plurality of retail stores related to products of interest to a potential buyer, the retail stores being presented in one embodiment on a map on the buyer's computer or buyer's device 115 based on their locations. Such a presentation is provided on a map displayed to the buyer on the buyer's device 115, buyer's computer 151 and other mobile devices. The system 105 also comprises a search/engine server 117 that facilitates retrieval and display of products available for sale from online sellers and brick and mortar stores onto mobile devices, tablets, laptops, etc. such as the buyer's device 115, wherein the criterion for retrieval comprises at least one policy or preference and may, in addition, comprise of user selections of products, services and coupons.

In one embodiment, the buyer of buyer's device 115 views a map on the buyer's device 115 displaying a retail store indicator on the digital map at the location of a brick and mortar store. It employs the mobile app 141 to display products for sale, and display the map with retail store indicators highlighting locations where the selected products can be inspected, tested, tried or observed prior to final purchase online. The retail store indicator (which is an icon, image, logo, etc.) is associated with the product(s) the buyer is currently interested in trying out (look & feel, etc) before purchasing online and is displayed at geographical coordinates associated with its location/address. In particular some of the retail store indicators are highlighted on the map displayed by the mobile app 141 (by a change of color, by a colored border, etc.) to draw attention to those that have the products currently available for trial or purchase. In response to the retail store indicator being selected on the map, the product information of the product associated with the selected retail store indicator is retrieved and displayed by the mobile app 141, and in addition, directions to and location of the retail store is provided. After a product and retail store information is displayed for a retail store selected, the buyer, typically an online shopper, can view any appointments currently made to visit the retail store. The promotion server 163 employs a database to store appointments made by buyers to visit retail stores, their status information, etc.

The online seller's system 109 comprises products on offer 133 (for example, organized as a searchable catalog), a publishing component 135 that publishes and makes available online the products on offer 133 in catalogs, search results, etc. It also comprises a buyer's and seller's profiles 159 that tracks what buyers buy, their patterns of buying, their contact information, their membership in social groups, their online buying accounts, security information such as passwords, the default locations for buyers, and their current location as reported by the buyer or the buyer's device 115, etc. The online seller's system 109 comprises a user behavior pattern analyzer 129 that determines when a user typically ends up purchasing, what type of products the user purchases, average price of those products, number of searches conducted by user before a typical purchase, etc. It also comprise an access manager 125 that facilitates remote access of accounts and purchased product status by buyers as well as management of updates to products on offer 133, etc. It comprises a pricing engine 127 that dynamically prices the products on offer 133 based on demand, supply and inventory, and a sequencing workflow manager 131 that facilitates product purchase accompanied by inventory management and dynamic pricing, etc.

The brick and mortar seller's system 107 comprises products on offer 155, a transaction manager 157 that conducts online sales transactions. It also comprises a trial coordination manager 121, which makes appointments for trail by buyers, helps manage trails, report completion of trials, etc. The brick and mortar seller's system 107 comprises remote access interface 123 that facilitates update of appointments, creation of trial appointments by the promotion system 161, retrieval of status of products available for sale or trail, etc. When a user typically completing a trial at the premises of the brick and mortar seller's system 107, the transaction manager 157 reports that to the promotion system 161 and subsequently (based on instructions from the promotion system 161 for example) conducts a trial fee payment transaction. In one related embodiment, when a buyer ends up purchasing a product online at a different online seller 109, the transaction manager 157 conducts a trial fee payment transaction.

In one embodiment, the brick and mortar seller requires the buyer coming for a trial to provide a token or a transaction id before conducting the trial, the token or a transaction id having been provided by the promotion server to the buyer when the buyer selects a product online for purchase and then decides to conduct a trial (look and feel test, for example) before completing the purchase. The buyer using the buyer device 115 or optionally the brick and mortar seller's system 107 reports the completion of the trial along with the token or transaction id, to facilitate payment of the trial fee, for example. If the product manufacturer or the online seller's system is reimbursing the trail fee to the brick and mortar seller's system 107, the token or transaction id is used to track and complete the trail fee payment transaction.

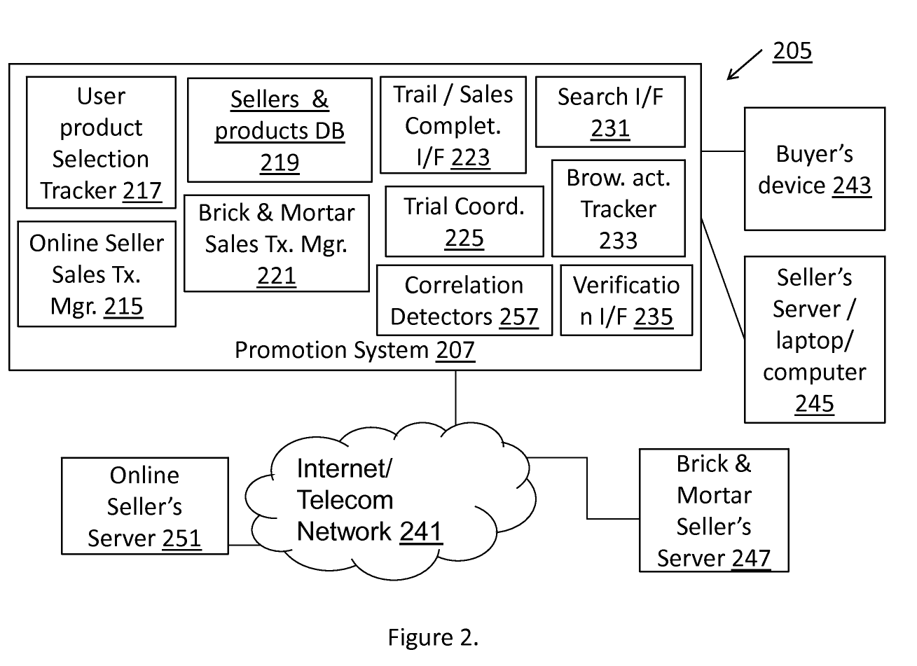

FIG. 2 is perspective block diagram of a sales infrastructure 205 with a promotion system 207 that makes it possible for a user to select a product online for purchase at a first online seller, try that same or similar product out at a retail brick and mortar store for a trail fee, and subsequently purchase it at the online seller. The promotion system 207 comprises user product selection tracker 217 that tracks what products a user is about to purchase, and then offers the buyer an opportunity to see the product, touch it, feel it, try it by arranging a trial at a local store close to the buyer. It comprises an online seller sales transaction manager 215 that conducts sales transactions for the buyer for the products the buyer is buying, that also conducts a transaction with the brick and mortar seller's system 247 in one embodiment to pay a trail fee for a trial conducted by the buyer, in ne related embodiment.

The promotion system 207 comprises a trial/sales completion interface 223 that received notification from a buyer's device 243 or the brick and mortar seller's system 247 informing it of the successfully completion of a trial by the buyer, so that it could not only conduct the online sales transaction for the products being purchased, but also initiates (in one embodiment) as necessary a trail fee payment transaction with the brick and mortar seller's system 247. The promotion system 207 comprises a trial coordinator 225 that is responsible for arranging a trial at a local store close to the buyer and following up with the buyer to make sure the buyer shows up for the trail as per an appointment made. It comprises correlation detectors 257 that detects correlation between the products sold to the same buyers, correlation between trial fees paid to brick and mortar sellers and the amount of sales conducted, correlation between product prices and trails with fees, etc.

The promotion system 207 comprises a search interface 231 that provides search results when a remoter buyer searches for products, for trails fees, details of trails arranged, of brick and mortar stores, department stores, showrooms and kiosks where a product is available for viewing, for trails, etc. It comprises a browser activity tracker 233 that (using scripts, window activity monitoring tools, downloadable programs, etc.) that tracks what products a buyer is trying to buy online at the online seller's server 251 and at what price, and also keeps track of buyer's request for a trail, buyers approval of a trail at a local brick and mortar store, etc. The promotion system 207 comprises a seller and products database 219 that keeps track of seller locations, products available for sale, brick and mortar store locations, trail fees to be aid, etc. It also comprises a brick and mortar sales transaction manager 221 that conducts trail fee related transactions, etc. and the trial/sales completion interface 223 that receives reports of trails completion, trial cancellation notification, as well as sales transaction completion reports/notifications from an online seller's sever 251 or a seller's server/laptop/computer 245.

The sales infrastructure 205 comprises a verification interface 235 that verifies trail fee payment requests by brick and mortar seller's server 247, verification of sales completion notifications and reports by the buyer's device and the online seller's server 251, etc.

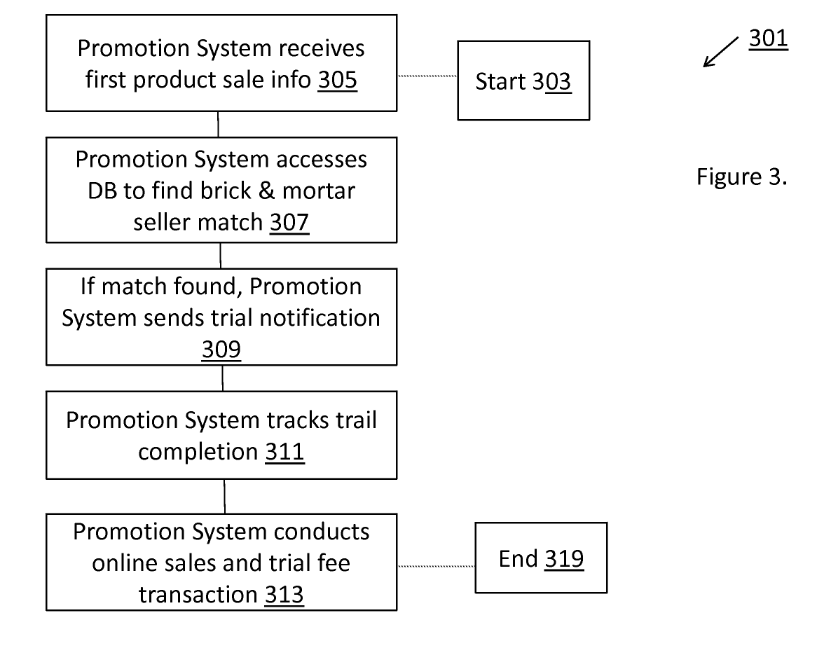

FIG. 3 is an exemplary method of operation 301 of a promotion system 207 that arranges product trials for an online buyer at a retail store for a trail fee, and also supports subsequent purchase at an online sales server. At a start block 303, the process starts when the promotion system monitors a buyer's online sales activity waiting to see what products get selected by the buyer. Then, at a next block 305, the promotion system 207 receives first product sale information after it determines that the first product has been selected for purchase by the buyer. Then at a next block 307, the promotion system 207 accesses the sellers and products database 219 to locate brick and mortar sellers of the first product in the local area (based on address of buyer or geographical area determined as GPS coordinates from the buyer's device 243, etc.). Then, at a next block 309, if the promotion system 207 determines if it has found a local store where the buyer can conduct a trial of the selected product, it sends a notification to both the local brick and mortar store (via the brick and mortar seller system 247) as well as the buyer with the product details and an appointment information for the trial, in addition to the address and contact information for the local brick and mortar store.

Then, at a next block 311, the promotion system 207 tracks the trial completion notification. It can be sent by the buyer's device 243 or the brick and mortar seller system 247 or both. At a next block 313, the promotion system 207 conducts online sales and trial fee transaction, in order to pay the brick and mortar store for the trail services provided, and also to make the online seller's server 251 to complete the sales transaction online for the product(s) being purchased by the buyer. Finally, at an end block 319, the promotion system 207 updates its database, and user behavior information.

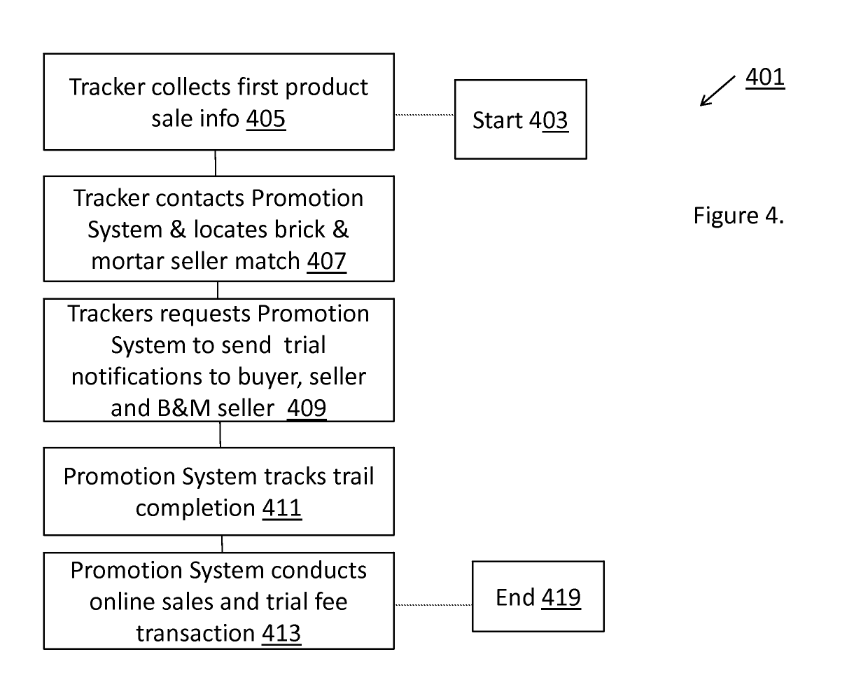

FIG. 4 is an exemplary method of operation 401 of a promotion system 207 that arranges product trials for an online buyer at a retail store for a trail fee, and also supports subsequent purchase at an online sales server. The promotion system 207 monitors the online purchase activity by the buyer, and then determines what products are being selected, and then provides an opportunity to conduct a product trial to the buyer for a trail fee.

At a start block 403, the process starts when the promotion system monitors a buyer's online sales activity waiting to see what products get selected by the buyer. For example, the tracker scripts/code from the promotion system are downloaded/loaded onto a web page viewed by the buyer such that subsequent product selections by the buyer are noticed by the tracker and reported to the promotion system 207 at a next block 407 where the promotion system locates a brick and mortar seller that matches the location of the buyer and the product selected for purchase by the buyer. Then, at a next block 409, the tracker requests the promotion system 207 to send a trial notification to the buyer as well as the brick and motor seller. For example, the promotion system 207 sends an email, an SMS text notification as well as an inapp notification to the buyer's device 243 as well as the online brick and mortar seller's server 247.

At a next block 411, the promotion system 207 tracks the completion of the product trial, as reported by the buyer using the buyer's device 243 or by the brick and mortar store using the online brick and mortar seller's server 247. It then conducts an online sales transaction to ensure that the online seller gets paid, as well as a trial fee transaction to ensure that the brick and mortar store gets the trial fee paid. Finally, the operation terminates at a next end block 419.

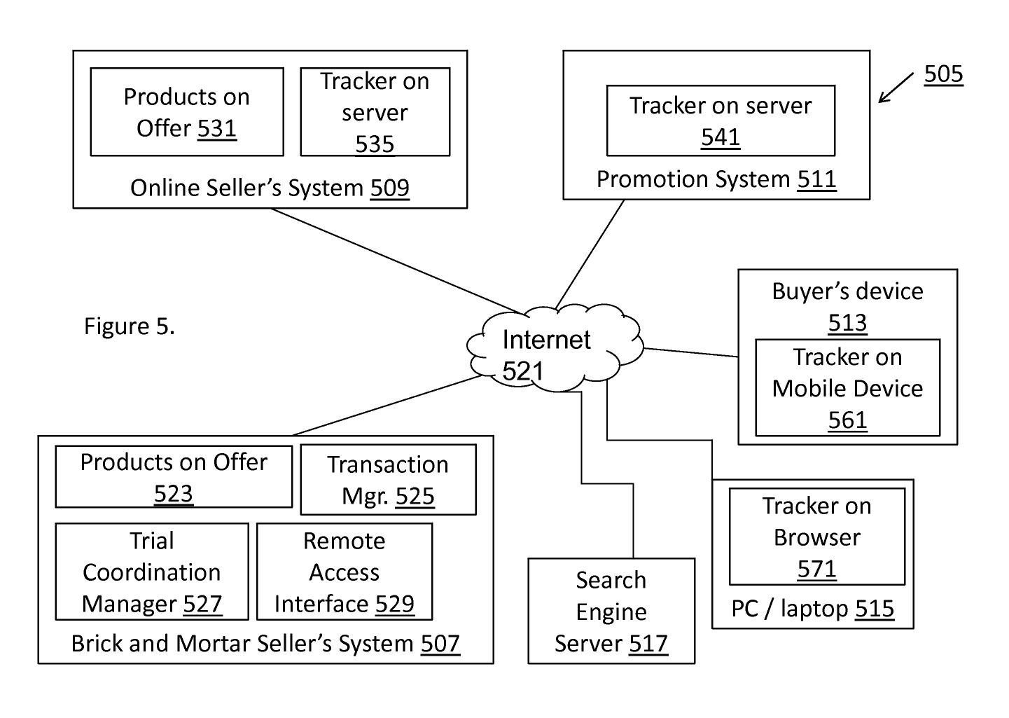

FIG. 5 is a perspective block diagram of an exemplary sales infrastructure 525 with a promotion system 511 that brings together an online seller's system 509 and a brick and mortar seller's system 507 and arranges a fee paid trail of a product at the brick and mortar seller's store for eventual online purchase of a product by the buyer at the online server's website. The online seller's system 509 comprises information on products on offer 531 as well as a tracker on the server 535 which keeps track of products selected by a user for purchase. In one embodiment, the tracker on server 535 is a javascript code that is loaded onto product webpages provided to the buyer, which subsequently monitors product selection on those webpages and helps report it to the online seller's system 509. In a related embodiment, the tracker on server 535 is a server-side executable code that is receives information for the product webpages provided to the buyer for display, which subsequently monitors product selection on those webpages and helps report it to the online seller's system 509. In yet another embodiment, the tracker on server 535 is a combination of client-side code such as java script etc. and a server-side code that receives product selection information from the client-side code, as the user selects product(s) on the buyer's device 513 or the PC/laptop 515, etc. The promotion system 511 also interacts with the tracker on server 535 to receive and process product selection information and subsequently arranges product trials with buyer approval.

The promotion system 511 interacts with a trial coordination manager 527 of a brick and mortar seller's system 507 to arrange product trail by a buyer based on selection of product(s) by the buyer. It receives status information on trails via a remote access interface 529, and it conducts trail fee related transaction interacting with the transaction manager 525 of the brick and mortar seller's system 507.

In one embodiment, if a buyer decides to buy the product at the brick and mortar store after an arranged trial, instead of buying it online later at the online seller's system 509, the promotion system 511 charges the brick and mortar seller's system 507 a referral fee and conducts a referral fee transaction with the help of the transaction manager 525.

The promotion server 511 employs a tracker on server 541 to receive product selection information from the tracker on server 535 of the online seller's system 509. It also employs the tracker on server 541 to receive and process trail completion notifications from the trial coordination manager 527 of the brick and mortar seller's system 507.

The tracker on the mobile device 561 that gets automatically (or manually by user) loaded to facilitate sales transactions makes it possible to monitor and report product selections by a buyer using the buyer's device 513. Similarly, the tracker on browser 571 that gets automatically (or manually by user) loaded onto to a browser used on the PC/laptop 515 facilitates sales transactions, making it possible to monitor and report product selections by the buyer currently using the PC/laptop 515.

Some prior art solutions allow a first user about to navigate using a map to a particular address to reach a brick and mortar premises, or to a historical landmark, famous restaurant, etc. However, these prior art navigational devices, or related systems, do not help in creating product trail arrangements based on products selections, that can be setup for a user of a mobile device. Thus, the present invention provides features useful for the arrangement of product trails to help a user purchase products, creation of product trail reports, and product evaluations that are communicated from the first user's mobile device to a database for subsequent sharing with the second user's mobile device.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

Although the present invention has been described in terms of GPS coordinates/and navigational information communication involving mobile phones and computers, it must be clear that the present invention also applies to other types of devices including mobile devices, laptops with a browser, a hand held device such as a PDA, a television, a set-top-box, a media center at home, robots, robotic devices, vehicles capable of navigation, and a computer communicatively coupled to the network.

Although the present invention has been described in terms of products for sale that one can purchase online, it must be clear that the present invention also applies to other types of items for sale including clothes, jewelry, electronic items, software, video games, watches, shoes, kitchen appliances, electronic goods and books.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A promotion system for sales supporting a plurality of buyer devices and a plurality of seller computers, the plurality of buyer devices used by a corresponding plurality of potential buyers, the plurality of seller computers used by a corresponding plurality of sellers, the promotion system comprising:
a promotion management service that receives from the plurality of sellers via the plurality of seller computers, a plurality of promotion data related to a plurality of respective offerings of the plurality of sellers;
the promotion management service identifying primary sellers and secondary sellers among the plurality of sellers;
the promotion management service receives and stores information regarding buyer interest of each of the plurality of potential buyers, wherein buyer interest comprises interest in at least one product or service from the plurality of respective offerings offered by the plurality of sellers;
the promotion management service, responsive to buyer interest input received from a first potential buyer via a first buyer device of the plurality of buyer devices, arranges for a look, feel, touch and try presentation of at least one product from the buyer interest input received, at a first premises associated with a first secondary seller among the secondary sellers;
the promotion management service, responsive to confirmation received of the participation of a first potential buyer in the look, feel, touch and try presentation at the first premises, conducts a first fee payment transaction that benefits the first secondary seller;
the promotion management service, responsive to confirmation received of an approval by the first potential buyer subsequent to the look, feel, touch and try presentation, conducts a first sales transaction with a first primary seller among the primary sellers for the of at least one product from the buyer interest input received.

2. The promotion system of claim 1 further comprising:
the promotion management service presents the plurality of promotion data via at least a subset of the plurality of buyer devices.

3. The promotion system of claim 1 further comprising:
the promotion management service, responsive to the buyer interest input received via a first buyer device of the plurality of buyer devices, communicates to the first buyer device promotion information for display and storage on the first buyer device, along with an appointment details for a look, feel, touch and try presentation of at least one product from the buyer interest input received, at the first premises associated with the first secondary seller among the secondary sellers.

4. The promotion system of claim 1 wherein the primary sellers are online sales businesses and the secondary sellers among are retail sales shops with corresponding sales premises.

5. The promotion system of claim 4 wherein the buyer interest input received from a first potential buyer via a first buyer device comprises a list of products that the corresponding buyer is interested in at the prices quoted for them.

6. The promotion system of claim 1 wherein the promotion management service determines a location of the first secondary seller based upon the selection of the corresponding a first primary seller by the first buyer and a current location of the first buyer device.

7. The promotion system of claim 1, wherein the promotion management service comprises a promotional server that hosts promotion data postings from the plurality of sellers.

8. The promotion system of claim 1, wherein each of the plurality of respective offerings comprises a good and/or a service.

9. The promotion system of claim 1, wherein the information regarding each of the plurality of potential buyers comprises a respective plurality of customer profiles.

10. The promotion system of claim 1, wherein each of the plurality of promotion data comprises a plurality of parameters.

11. A sales promotion system supporting a plurality of buyer devices used by a corresponding plurality of buyers, the sales promotion system comprising:
a promotion server that supports promotion of sales of a plurality of products from a plurality of sellers, including a first product from a first seller;
the promotion server responsive to a selection of the first product received from one of the plurality of buyer devices, delivers to the one of the plurality of buyer devices a first trial presentation offer at a second seller premises at a first trail fee;
the promotion server responsive to a trail offer acceptance received related to the first trial presentation offer, makes an appointment for a visit to the second seller premises by one of the plurality of buyers associated with the one of the plurality of buyer devices to conduct a trail;
the promotion server responsive to a receipt of a successful trail indication from the one of the plurality of buyer devices, conducts a first sales transaction with the first seller for the first product, and in addition, conducts a fee payment transaction for the first trial presentation with the second seller.

12. The sales promotion system of claim 11 wherein the first seller is an online only seller with online presence on the Internet while the second seller is a brick and mortar seller with one or more physical sales premises.

13. The sales promotion system of claim 11 wherein the first seller pays the fees associated with fee payment transaction for the first trial presentation with the second seller.

13. The sales promotion system of claim 11 wherein the one of the plurality of buyers associated with the one of the plurality of buyer devices pays the fees associated with fee payment transaction for the first trial presentation with the second seller.

14. The sales promotion system of claim 11 wherein a product manufacturer associated with the first product pays the fees associated with fee payment transaction for the first trial presentation with the second seller.

15. The sales promotion system of claim 11 wherein the trial comprises a look, feel, touch and try experience.

16. A method used by a sales promotion system supporting a plurality of buyer devices used by a corresponding plurality of buyers, the method comprising:
promoting sales of a plurality of products from a plurality of sellers, including a first product from a first seller, by a promotion server in the sales promotion system;
responding to a selection of the first product received from one of the plurality of buyer devices by delivering to the one of the plurality of buyer devices a first trial presentation offer at a second seller premises at a first trail fee;
responding to a trail offer acceptance received related to the first trial presentation offer by making an appointment for a visit to the second seller premises by a user associated with the one of the plurality of buyer devices to conduct a trail; and
responding to a receipt of a successful trail indication from the one of the plurality of buyer devices by conducting a first sales transaction with the first seller for the first product, and in addition, conducting a fee payment transaction for the first trial presentation with the second seller;
wherein the trial comprises a look, feel, touch and try experience.

17. The method of claim 16 wherein the first seller is an online only seller with online presence on the Internet while the second seller is a brick and mortar seller with one or more physical sales premises.

18. The method of claim 16 wherein the first seller pays the fees associated with fee payment transaction for the first trial presentation with the second seller.

19. The method of claim 16 wherein the one of the plurality of buyers associated with the one of the plurality of buyer devices pays the fees associated with fee payment transaction for the first trial presentation with the second seller.

20. The method of claim 16 wherein a product manufacturer associated with the first product pays the fees associated with fee payment transaction for the first trial presentation with the second seller.
